(19) United States
(12) Patent Application Publication
(10) Pub. No.: US 2008/0219370 A1
(43) Pub. Date: Sep. 11, 2008

(54) USER EQUIPMENT FEEDBACK STRUCTURES FOR MIMO OFDMA

(75) Inventors: Eko N. Onggosanusi, Allen, TX (US); Runhua Chen, Dallas, TX (US); Zukang Shen, Richardson, TX (US); Badri Varadarajan, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/042,246

(22) Filed: Mar. 4, 2008

Related U.S. Application Data
(60) Provisional application No. 60/893,294, filed on Mar. 6, 2007.
(60) Provisional application No. 60/988,891, filed on Nov. 19, 2007.
(60) Provisional application No. 61/024,727, filed on Jan. 30, 2008.

(51) Int. Cl. H04K 1/10

(52) U.S. Cl. 375/260

(57) ABSTRACT

Embodiments of the present disclosure provide a feedback encoder, a feedback decoder and methods of operating the same. The feedback encoder, for use with user equipment, includes an encoding module configured to provide a rank indicator that is separately reportable from a related selection of at least one of a channel quality indicator and a preceding matrix indicator for the user equipment. The feedback encoder also includes a transmit module configured to transmit the rank indicator and the related selection. The feedback decoder, for use with a base station, includes a receive module configured to receive a rank indicator that is separately reportable from a related selection of at least one of a channel quality indicator and a preceding matrix indicator for user equipment. The feedback decoder also includes a decoding module configured to decode the rank indicator and the related selection for the base station.

### CROSS-REFERENCE TO PROVISIONAL APPLICATION

This application claims the benefit of U.S. Provisional Application No. 60/893,294 entitled “RUE Feedback Structure for MIMO OFDMA” to Eko Onggosanusi, et al., filed on Mar. 6, 2007, which is incorporated herein by reference in its entirety.

This application also claims the benefit of U.S. Provisional Application No. 60/988,891 entitled “UE Feedback Structure for MIMO OFDMA” to Eko Onggosanusi, et al., filed on Nov. 19, 2007, which is incorporated herein by reference in its entirety.

This application further claims the benefit of U.S. Provisional Application No. 61/024,727 entitled “UE Feedback Structure for MIMO OFDMA” to Eko Onggosanusi, et al., filed on Jan. 30, 2008, which is incorporated herein by reference in its entirety.

### TECHNICAL FIELD

The present disclosure is directed, in general, to a communication system and, more specifically, to a feedback encoder, a feedback decoder and methods of operating a feedback encoder and a feedback decoder.

### BACKGROUND

A key principle in orthogonal frequency division multiple access (OFDMA) communication systems is that the total operating bandwidth is divided into sub-carriers, also called resource blocks (RBs), where transmissions for user equipment (UE) occur in an orthogonal (i.e., not mutually interfering) manner. Each RB can potentially carry data to a different UE. More typically, each UE will obtain a well chosen set of RBs where it has a high signal-to-interference and noise ratio (SINR). This allows the spectral efficiency of the transmission to be maximized according to the operating principle of a scheduler at a serving base station (Node-B). By scheduling each UE on RBs where it has high SINR, the data rate transmitted to each UE, and therefore the overall system throughput, can be optimized according to the scheduling principle. Improvements in the process of feeding back information from the UE to the Node-B would prove beneficial in the art.

### SUMMARY

Embodiments of the present disclosure provide a feedback encoder, a feedback decoder and methods of operating a feedback encoder and a feedback decoder. In one embodiment, the feedback encoder is for use with user equipment and includes an encoding module configured to provide a rank indicator that is separately reportable from a related selection of at least one of a channel quality indicator and a preceding matrix indicator for the user equipment. Additionally, the feedback encoder also includes a transmit module configured to transmit the rank indicator and the related selection. In one embodiment, the feedback decoder is for use with a base station and includes a receive module configured to receive a rank indicator that is separately reportable from a related selection of at least one of a channel quality indicator and a preceding matrix indicator for user equipment. The feedback decoder also includes a decoding module configured to decode the rank indicator and the related selection for the base station.

In another aspect, the present disclosure provides a method of operating a feedback encoder for use with user equipment. In one embodiment, the method includes providing a rank indicator that is separately reportable from a related selection of at least one of a channel quality indicator and a preceding matrix indicator for the user equipment and transmitting the rank indicator and the related selection. In one embodiment, the method of operating a feedback decoder is for use with a base station. The method includes receiving a rank indicator that is separately reportable from a related selection of at least one of a channel quality indicator and a preceding matrix indicator for user equipment and decoding the rank indicator and the related selection for the base station.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1A illustrates a system diagram of user equipment as provided by one embodiment of the disclosure;

FIG. 1B illustrates a system diagram of a base station as provided by one embodiment of the disclosure;

FIG. 2 illustrates a diagram of a frequency-time operating resource space as may be employed by an OFDMA communications system such as shown in FIGS. 1A and 1B.

FIGS. 3A through 3H illustrate diagrams of various encoding and multiplexing schemes as may be employed between a UE and a Node-B such as shown in FIGS. 1A and 1B;

FIG. 4A illustrates a diagram of a radio frame as may be employed in communications between a UE and a Node-B such as shown in FIGS. 1A and 1B;

FIGS. 4B through 4G illustrate sub-frame diagrams of various multiplexing schemes as may be employed between a UE and its Node-B corresponding to various embodiments of the present disclosure;

FIG. 5 illustrates a flow diagram of an embodiment of a method of operating a feedback encoder carried out according to the principles of the present disclosure; and

FIG. 6 illustrates a flow diagram of an embodiment of a method of operating a feedback decoder carried out according to the principles of the present disclosure.

### DETAILED DESCRIPTION

To enable a more optimum frequency domain scheduling of UEs in the RBs of the operating bandwidth, each UE feeds back a channel quality indicator (CQI) that it is experiencing or might potentially experience for each RB or some combination of RBs to its serving Node-B. Some examples of the CQI include SINR, recommended or supportable spectral efficiency, recommended or supportable modulation-and-coding scheme (MCS), which indicates the modulation scheme and channel coding rate, and mutual information. Since CQI is typically quantized or discrete, a set of possible CQI values may be predefined and indexed, and the index of the corresponding CQI value is reported. In addition to the CQI feedback, other types of UE feedback are required for multiple-input multiple-output (MIMO) technology.

Precoding selection feedback, which enables selection of codebook-based preceding, allows the UE to indicate a preferred preceding matrix or vector to the Node-B. A preceding matrix indicator (PMI) value essentially corresponds to a codebook index, which indicates the selected preceding matrix/vector. Rank selection feedback from the UE allows the Node-B to adapt a transmission rank, which is the recommended number of useful spatial streams or transmission layers for spatial multiplexing in MIMO transmissions.

A rank indicator (RI) value ranges from one to the maximum number of supportable transmission layers. For example, for a P-transmit and Q-receive antenna (P×Q MIMO) system, the maximum number of supportable transmission layers is min(P,Q). In addition, for multiple-codeword MIMO systems, more than one codeword may be used when the rank is greater than one. In this case, each codeword may be assigned a different MCS. Hence, the CQI consists of a recommended MCS for each of the codewords. Consequently, the CQI payload size (measured in terms of the number of bits) varies depending on the RI. Furthermore, it is also possible that the preceding codebook size is rank-dependent.

For OFDMA systems, the above UE feedbacks are signaled to the Node-B based on a certain time periodicity (e.g., every five milliseconds) and frequency granularity (e.g., each feedback corresponds to five RBs) periodicity. In general, the periodicity and/or granularity are configurable by the Node-B or network based on the channel condition, the system load and application. Embodiments of the present disclosure accommodate closed-loop spatial multiplexing (where PMI is signaled) and open-loop spatial multiplexing (where PMI is not signaled). These embodiments provide an efficient approach for the structure of UE feedback.

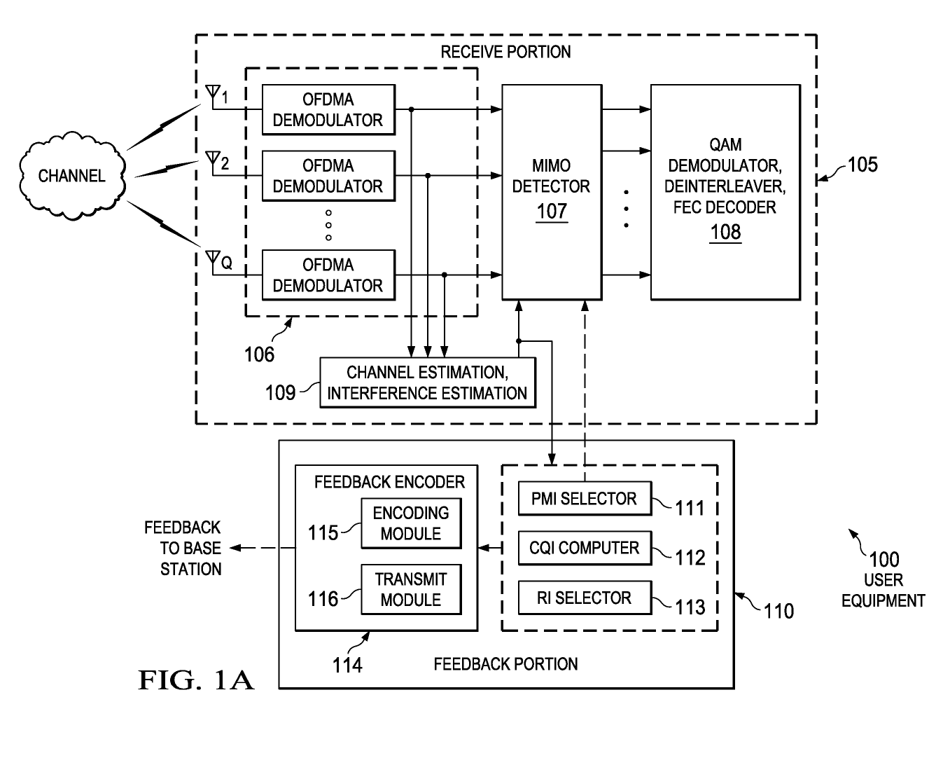

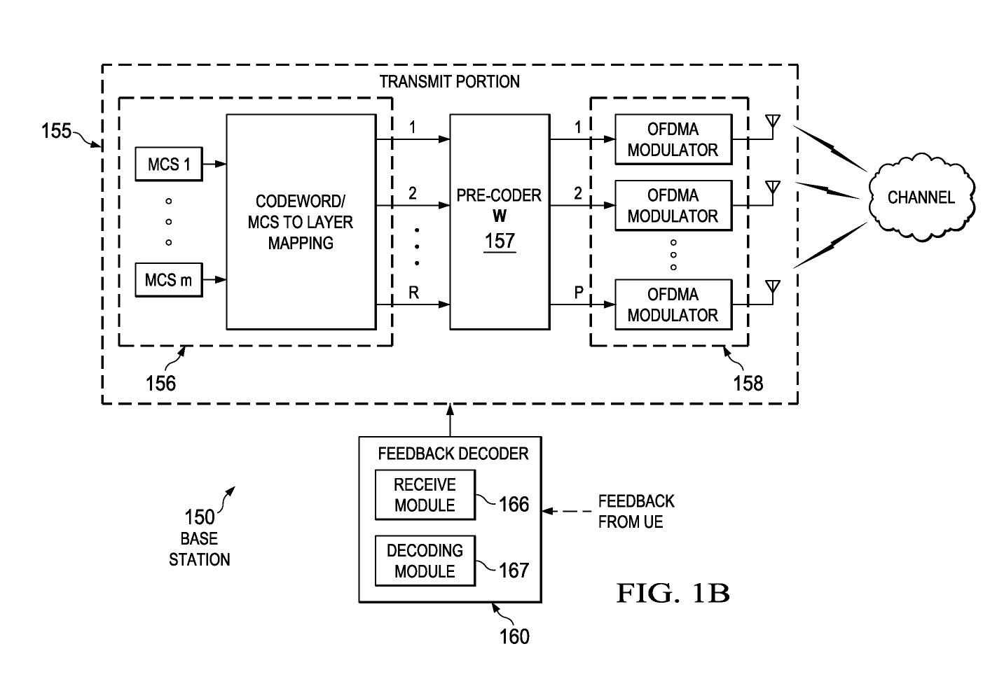

FIG. 1A illustrates a system diagram of user equipment 100 as provided by one embodiment of the disclosure. In the illustrated embodiment, the UE 100 operates in an OFDMA communications system. The UE 100 includes a receive portion 105 and a feedback portion 110. The receive portion 105 includes an OFDM module 106 having Q OFDM demodulators (Q is at least one) coupled to corresponding receive antenna(s), a MIMO detector 107, a QAM demodulator, deinterleaver and FEC decoding module 108 and a channel and interference estimation module 109. The feedback portion 110 includes a PMI selector 111, a CQI computer 112, an RI selector 113, and a feedback encoder 114.

In the UE 100, the receive portion 105 employs transmission signals from a base station having multiple transmit antennas that is capable of transmitting at least one spatial codeword and adapting a transmission rank. The feedback encoder 114 includes an encoding module 115 and a transmit module 116. The encoding module 115 is configured to provide an RI that is separately reportable from a related selection of at least one of a CQI and a PMI for the UE 100. The transmit module 116 is configured to transmit the RI and the related selection.

The receive portion 105 is primarily employed to receive data from the base station based on a precoder selection that was determined by the UE 100 and feedback to the base station. The OFDM module 106 demodulates the received data signals and provides them to the MIMO detector 107, which employs channel estimation, interference estimation and precoder information to further provide the received data to the module 108 for further processing (namely QAM demodulation, de-interleaving, and FEC decoding). The channel and interference estimation module 109 employs previously transmitted channel estimation signals to provide the channel estimates needed by the UE 100.

The feedback portion 110 determines the information to be fed back to the base station. It comprises the PMI selector 111, the CQI computer 112 and the RI selector 113. For each possible transmission rank (or for some set of possible transmission ranks), the PMI selector 111 and the CQI computer 112 determine the PMI and CQI feedback. These modules use the channel and noise-variance/interference estimates computed by the receive portion 105. The RI selector 113 then makes a choice of the set of ranks for which the information needs to be fed back. The feedback encoder 114 then encodes the PMI selection and the CQI selection and feeds it back to the base station.

FIG. 1B illustrates a system diagram of a base station 150 as provided by one embodiment of the disclosure. In the illustrated embodiment, the base station (Node-B) 150 operates in an OFDMA communication system. The Node-B 150 includes a transmit portion 155 and a feedback decoder 160. The transmit portion 155 includes a modulation and coding scheme module 156, a precoder module 157 and an OFDMA module 158 having multiple OFDMA modulators that feed corresponding transmit antennas. The feedback decoder 160 includes a receive module 166 and a decoding module 167.

The Node-B 150 has multiple transmit antennas and is capable of transmitting at least one spatial codeword and adapting a transmission rank. The receive module 166 is configured to receive an RI that is separately reportable from a related selection of at least one of a CQI and a PMI for user equipment such as the UE 100. The decoding module 167 is configured to decode the RI and the related selection for the Node-B 150.

The transmit portion 155 is employed to transmit data provided by the MCS module 156 to the UE 100 based on preceding provided by the precoder module 157. The MCS module 156 takes m codewords, where m is at least one, and maps the codewords to the R spatial layers or transmit streams, which is derived from the decoded RI. That is, R is the transmission rank, which is at least one. Each codeword consists of FEC-encoded, interleaved, and modulated information bits. The selected modulation and coding rate for each codeword are derived from the CQI. A higher CQI typically implies that a higher data rate may be used. The precoder module 157 may employ a precoder selection obtained from the feedback decoder 160.

The receive module 166 accepts the feedback and the decode module 167 provides it to the MCS module 156. Once the R spatial layers are generated from the MCS module 156, a precoder is applied to generate P≧R output streams. The precoder W is selected from a codebook, which corresponds to the codebook that is used by the UE 100. Using preceding, the R spatial streams are cross-combined linearly into P output data streams. For example, if there are 16 matrices in the preceding codebook, a precoder index corresponding to one of the 16 matrices for the resource block (say five, for example) may be signaled from the UE to the Node-B 150 for each group of resource blocks. The precoder index then tells the Node-B 150 which of the 16 matrices to use.

Note that the embodiments in FIGS. 1A and 1B correspond to closed-loop spatial multiplexing where PMI is reported by the UE 100 and used to select a precoder at the Node-B 150. Another possible mode of operation is open-loop spatial multiplexing where PMI is not reported or used to select a precoder at the Node-B 150. In both operational modes, CQI and RI may still be reported.

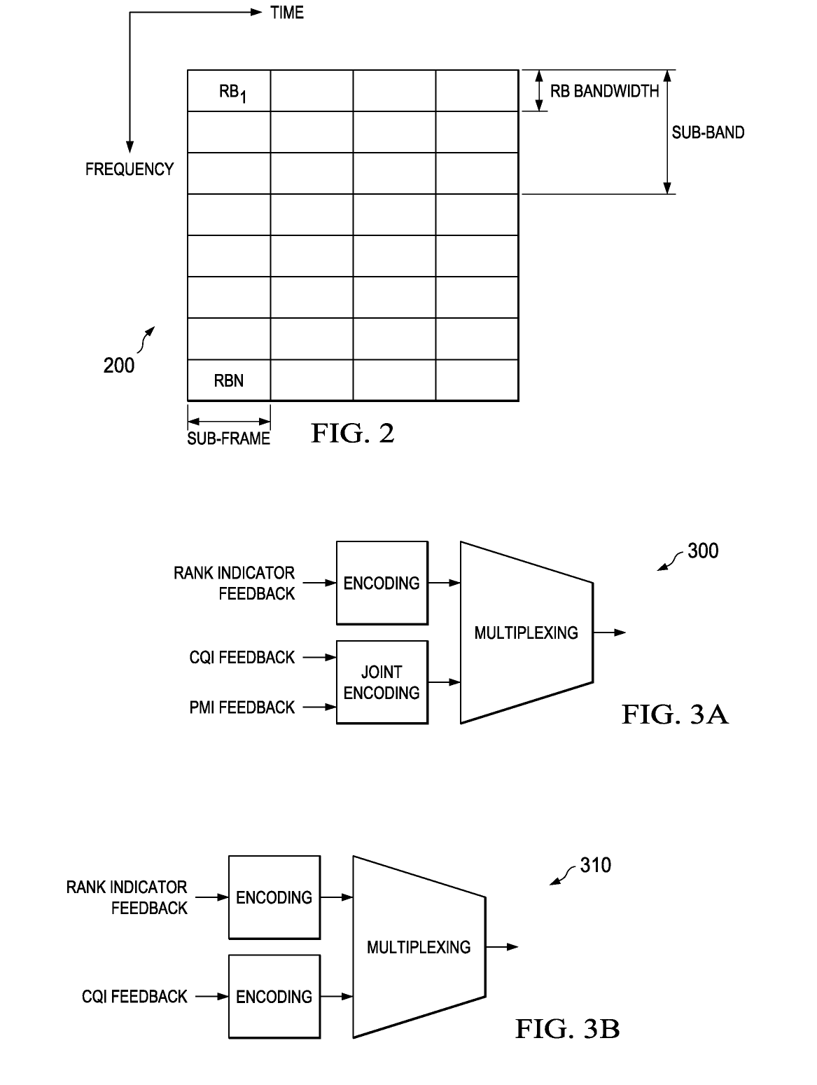

FIG. 2 illustrates a diagram of a frequency-time operating resource space 200 as may be employed by an OFDMA communications system such as shown in FIGS. 1A and 1B. An operating bandwidth of the operating resource space 200 may be divided into N resource blocks (RB₁-RB_{N}) wherein each of the N resource blocks may be defined as a set of adjacent sub-carriers (tones). For example, a 3GPP LTE system with 5 MHz bandwidth employs 25 RBs wherein each has a 180 kHz bandwidth for a total operating bandwidth of 4.5 MHz, with the remaining 0.5 MHz providing a guard band separating transmissions on two adjacent bands on different cells.

A sub-band of the operating bandwidth corresponds to a collection of one or more RBs, as shown. One sub-band is defined as the smallest unit for CQI reporting. That is, the RBs may also be concatenated to form larger ones thereby fundamentally reducing the CQI reporting overhead and the control channel overhead in the downlink that signals their allocated RBs to UEs that have been scheduled. Based on the channel and interference and noise variance estimates, the UE computes a CQI for each RB, which may be denoted S₁,S₂, . . . ,S_{N}. As mentioned before, some examples of CQI are SINR, recommended or supportable spectral efficiency, recommended or supportable modulation-and-coding-scheme (MCS), received signal strength and mutual information. Since the CQI is typically quantized or discrete, a set of possible CQI values may be predefined and indexed, and the index of the corresponding CQI value is reported.

Each of the UE feedback quantities, namely CQI, PMI, and RI may be reported with different frequency granularities. For instance, RI may be reported for the entire system bandwidth while CQI+PMI may be reported for each of the sub-bands within the entire system bandwidth. It is also possible, however, to report RI, CQI, and PMI for the entire system bandwidth. Such reporting is usually called wideband reporting, i.e., wideband CQI, wideband PMI, and wideband RI.

With continued reference to FIGS. 1A and 1B as exemplary, various embodiments of the present disclosure are presented and discussed below. With joint encoding of the CQI, PMI and RI into one codeword, the number of possible sizes for the feedback codeword is large. For instance, assuming a 4-antenna scenario and fully rank-specific codebook size, there are at least four possible codeword sizes. While it is possible for the Node-B to perform hypothesis testing for all eight possible sizes, this not only increases complexity but also degrades detection performance.

It may also be shown that the optimum rank tends to track long-term variation of a channel. Therefore, the optimum rank may be expected to vary more slowly, sometimes significantly, when compared to the CQI and PMI selections. In this case, a RI report may be transmitted less frequently compared to CQI and PMI feedbacks. Furthermore, RI tends to require coarser frequency granularity compared to CQI and/or PMI. For instance, it suffices to report RI for the entire system bandwidth while CQI and/or PMI may need to be reported for each of the sub-bands within the system bandwidth. In addition, rank selection fully specifies the size of CQI and PMI selection feedbacks. Therefore, if the rank selection is known at the Node-B prior to decoding the CQI and PMI selection feedbacks, the Node-B is typically able to decode the CQI and PMI selections without appreciable ambiguity in the feedback codeword size. Such implementation advantage is also seen by the UE in terms of reducing the computational complexity. For example, say RI=2 is reported every 10 ms and CQI+PMI is reported every two ms. In sub-frame 1, rank-2 is selected and will be fixed during the next 10 sub-frames. Then, at sub-frames 1, 3, 5, 7 and 9, PMI selection is performed only within the rank-2 codebook.

Motivated by these aspects, embodiments of the present disclosure provide the following structure for encoding the UE feedback information. RI selection feedback is separately defined, encoded or reportable from the CQI and PMI selection feedbacks. Embodiments consider that CQI and PMI selection feedback share a same time reporting period and comparable frequency granularity requirements. For this reason, they are jointly encoded.

The two separate coded entities (RI selection feedback and CQI and PMI selection feedback) are multiplexed into the uplink channel between the UE and the Node-B. This multiplexing is within the resources allocated to data transmission if data and feedback transmissions occur simultaneously. Alternately, this multiplexing occurs within resources allocated exclusively to control signaling if the UE has only feedback transmission. Here, multiplexing is done within the reporting resource(s) of one sub-frame (time and/or frequency-domain) as well as across multiple reporting sub-frames or instances.

The Node-B first decodes the rank feedback coded entity. The rank information uniquely specifies the size of the second coded entity, containing the CQI and PMI feedback information and facilitates the decoding of the second coded entity. Since RI may not need to be reported at the same feedback rate as the CQI or PMI selection feedback, the multiplexing also involves the time aspect. That is, in some reporting instances, the RI is not transmitted. This does not rule out the possibility of always transmitting the RI together with CQI or PMI feedbacks.

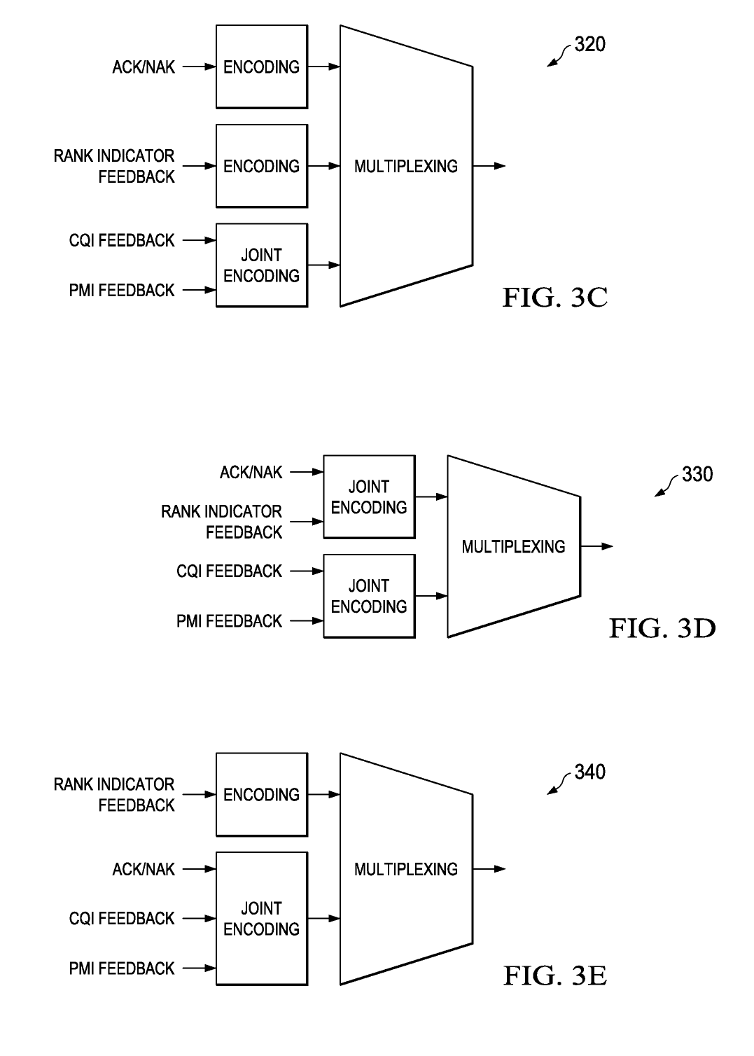

FIGS. 3A through 3H illustrate diagrams of various encoding and multiplexing schemes 300-370 as may be employed between a UE and a Node-B such as shown in FIGS. 1A and 1B. Encoding encompasses introducing repetition into the information (i.e., different number of hypotheses) as well as modulating the resulting information into signals by using an error correcting code (e.g., block code or convolutional code) and modulation scheme.

A number of encoding schemes may apply. For example, since the size of the first coded entity (carrying the RI) is small (one bit for two Node-B transmit antennas and two bits for four Node-B transmit antennas), a simple BPSK/QPSK signaling with repetition coding can be used. Orthogonal signaling can also be used if non-coherent detection applies to the RI transmission. For the second coded entity, which is larger, an error correcting code (e.g. convolutional, block, or Turbo code) with possible interleaving and QPSK modulation can be used. Of course, other possibilities are not precluded.

Other possible embodiments include the transmission of the above UE feedback information with acknowledged/not acknowledged (ACK/NAK), which is transmitted by the UE in response to downlink data transmission. ACK/NAK can be separately encoded or jointly encoded with any of the two UE feedback codewords. These embodiments do not limit the functionality described above. The Node-B can first decode the RI prior to decoding the CQI and PMI feedback information. Notice, that if an ACK/NAK is jointly encoded with other feedback information, the Node-B already expects such transmission, and the number of ACK/NAK bits is also known in advance by the Node-B. Therefore, additional hypotheses may not need to be introduced in the decoding process if the Node-B assumes that the user equipment successfully detects the data resource assignment from the Node-B. Similar to the first embodiment, RI may not need to be reported at the same feedback rate as CQI or PMI feedback. Multiplexing also involves a time aspect. That is, in some reporting instances, the RI is not transmitted. Note that this does not rule out the possibility of always transmitting the RI together with the CQI or PMI feedbacks.

Another possibility is to jointly encode CQI and PMI feedback and RI when the RI is reported. However, the RI is not reported in every CQI reporting instance. Hence, although the joint encoding structure is used for CQI and PMI feedback and RI, it is still possible to skip the RI report since the RI reporting may be made less frequently.

Yet another possibility is rate matching to make sure codeword sizes are the same, or at least to reduce the number of hypotheses. Particularly, there is a way to make sure that the coded entities corresponding to different ranks have the same size because they feed back the same quantities. The only difference may be in the precoder size. To equalize the size, one could add a CRC to rank 3 and 4 transmissions to make the sizes equal, particularly since these UEs are close to the Node-B. Along the same lines, another possibility is to never feedback the RI explicitly but use a spreading sequence or cyclic redundancy check (CRC), thus aiding blind detection.

In the embodiment depicted in FIG. 3A, the encoding and multiplexing scheme (EMS) 300 shows an encoded RI feedback that is multiplexed with jointly encoded CQI and PMI feedback as may be employed for closed-loop spatial multiplexing. As previously indicated, the multiplexing is performed within one reporting sub-frame/instance as well as across multiple reporting sub-frames/instances. In FIG. 3B, the EMS 310 shows an encoded RI feedback that is multiplexed with an encoded CQI feedback as may be employed for open-loop spatial multiplexing.

FIGS. 3C, 3D and 3E show encoding and multiplexing schemes employing the use of an acknowledged/not acknowledged signal (ACK/NAK) that may be employed for closed-loop spatial multiplexing. The EMS 320 shows separately encoded ACK/NAK and RI feedback that are multiplexed with jointly encoded CQI and PMI feedback. The EMS 330 shows jointly encoded ACK/NAK and RI feedback that are multiplexed with jointly encoded CQI and PMI feedback. The EMS 340 shows separately encoded RI feedback that is multiplexed with a jointly encoded ACK/NAK, CQI and PMI feedback.

FIGS. 3F, 3G and 3H show encoding and multiplexing schemes employing the use of an acknowledged/not acknowledged signal (ACK/NAK) that may be employed for open-loop spatial multiplexing. The EMS 350 shows separately encoded ACK/NAK, RI feedback and CQI feedback signals that are multiplexed. The EMS 360 shows jointly encoded ACK/NAK and RI feedback that is multiplexed with separately encoded CQI feedback. The EMS 370 shows a separately encoded RI feedback that is multiplexed with a jointly encoded ACK/NAK and CQI.

The flexibility to report RI separately from CQI (and/or PMI feedback) implies different ways in configuring the RI report relative to the CQI (and/or PMI feedback). Denote the reporting interval for RI and CQI as R_{R} and R_{C}, respectively. Here, it is assumed that the reporting interval of CQI and PMI is the same. Note that the concepts presented in the present disclosure still hold, even if the reporting intervals for CQI and PMI were different. Some examples are provided below.

R_{R} is related to R_{C}. For instance:
1) R_{R} is N times longer than R_{C} where N≧1 (not necessarily an integer). Here, R_{C} is configurable from a set of values (e.g. 2 ms, 5 ms).
2) R_{R} is chosen to be the maximum of possible values of R_{C}.
3) R_{R} is chosen to be larger than the maximum of possible values of R_{C} (e.g., if R_{C} can be either 2 ms or 5 ms, R_{R} can be chosen as 10 ms).

If R_{R} is larger than 10 ms (1 radio frame), the rank report can be tied/related to the system frame number (SFN). In that case, the exact location of the rank report (in terms of sub-frame) can also be specified. For instance, if R_{R} is 20 ms, the rank report can be specified to occur when mod(SFN,2) is 0 and at the first (or sixth) sub-frame within that radio frame 400.

When RI is reported, the RI report can also be specified to either coincide with CQI report or be reported in different sub-frames (not to coincide with a CQI report). The above configuration for an RI report can be UE-specific or cell-specific or some combination of UE- and cell-specific. Of course, combinations of the above examples are embodiments of the present disclosure.

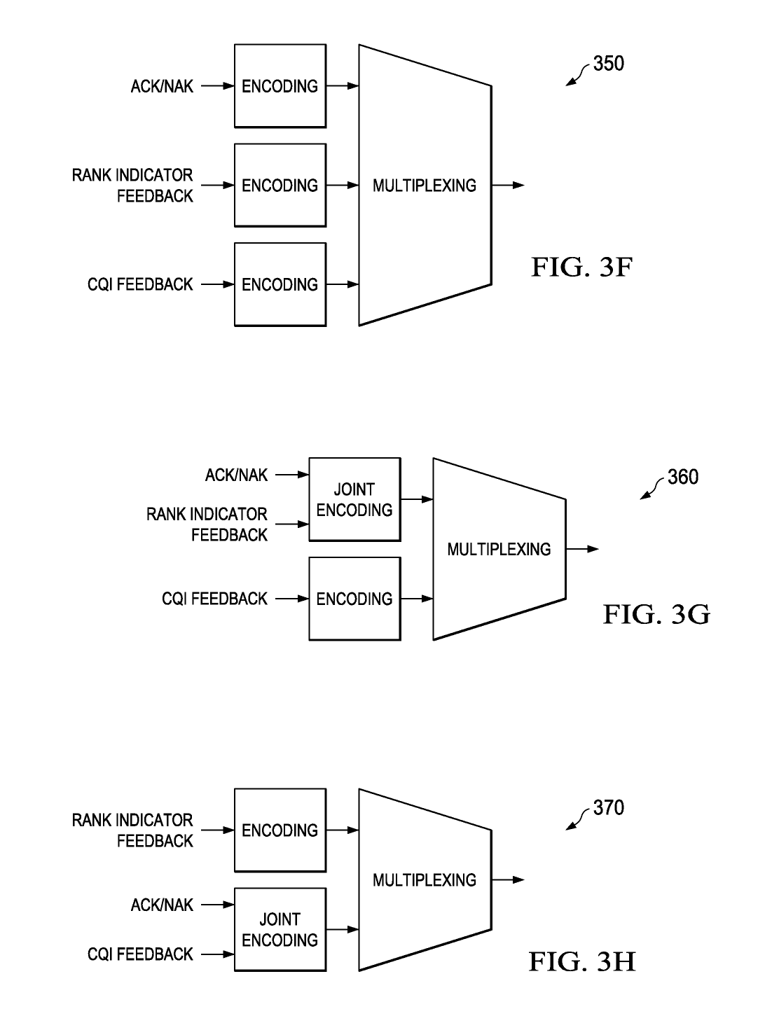

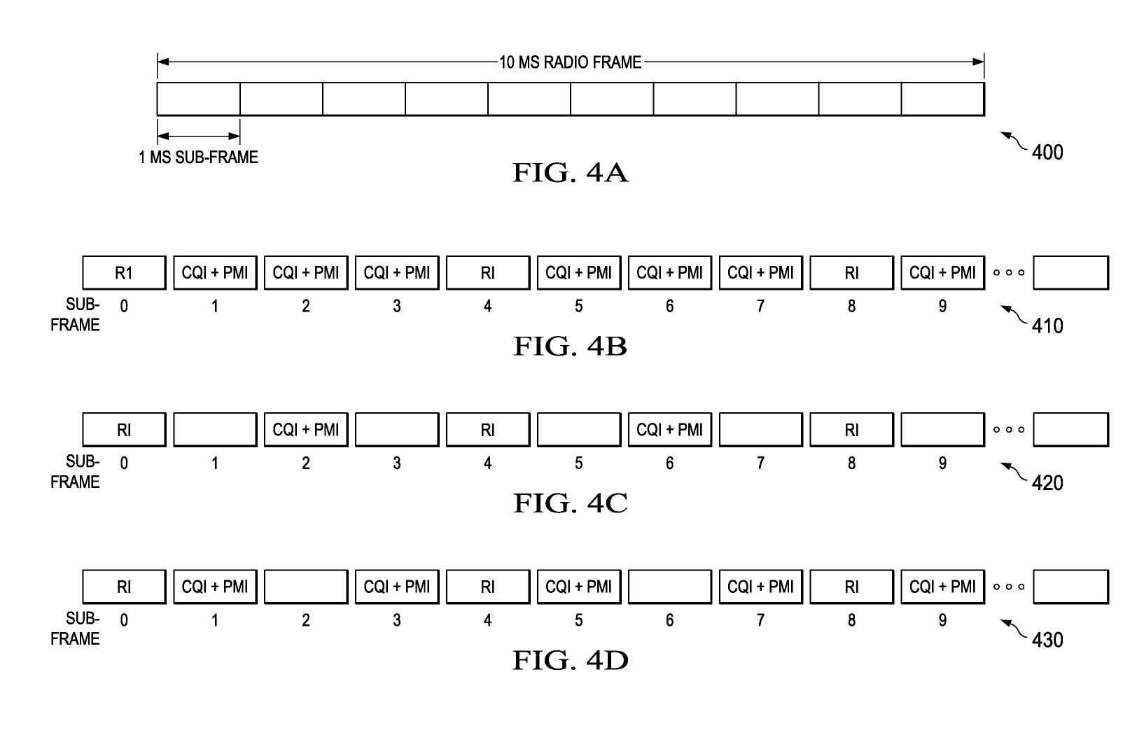

FIG. 4A illustrates a diagram of a radio frame 400 as may be employed in communications between a UE and a Node-B such as shown in FIGS. 1A and 1B. The radio frame 400 includes 10 sub-frames that have durations of one millisecond each and allows synchronized communications between the UE and the Node-B.

FIGS. 4B through 4G illustrate exemplary sub-frame diagrams of various multiplexing schemes 410-460 as may be employed between a UE and its Node-B corresponding to various embodiments of the present disclosure. The sub-frame diagrams 410-460 correspond to the sub-frame timing supported by the radio frame 400 for various combinations where a separately reportable RI is employed by a collection of subsequent sub-frame feedback selections, as shown. In the illustrated embodiments, it is assumed that PMI is jointly encoded with CQI, which corresponds to the closed-loop spatial multiplexing.

The sub-frame diagram 410 illustrates the reporting of RI once every four sub-frames wherein CQI+PMI is reported in every sub-frame except in the sub-frames where RI is reported. Similar multiplexing is also depicted in the sub-frame diagram 420 wherein CQI+PMI is reported every two sub-frames except in the sub-frames where RI is reported. Essentially, sub-frame diagrams 410 and 420 illustrate a multiplexing embodiment showing CQI+PMI and RI reported in different reporting sub-frames/instances, CQI+PMI reported every N sub-frames and RI reporting replacing/superseding the CQI+PMI reporting every M reporting instances.

The sub-frame diagram 430 illustrates the reporting of RI once every four sub-frames with CQI+PMI reported in every two sub-frames. Unlike the sub-frame diagram 420, an offset of one sub-frame is introduced between RI and CQI+PMI to avoid collision between RI and CQI+PMI reporting (which results in erasures of CQI+PMI reports). This illustrates a multiplexing embodiment with CQI+PMI reported every N₁ sub-frames, and RI reported every N₂≧N₁ sub-frames where an offset in time is introduced between CQI+PMI and RI reporting. This avoids or at least minimizes the erasure of either CQI+PMI or RI when reporting collision occurs.

The corresponding embodiments in FIGS. 4B, 4C, and 4D ensure that CQI+PMI and RI are not reported in the same sub-frame or reporting instances. In this case, RI reporting can employ the same reporting scheme and/or format as that for CQI+PMI reporting with the exception of the payload difference. Since RI incurs a much smaller payload compared to CQI+PMI (e.g., for 3GPP E-UTRA, one to two bits for RI as opposed to six to eleven bits for CQI+PMI), RI benefits from a larger coding or repetition gain than that of CQI+PMI. Hence, RI is more protected that CQI+PMI which is a desirable property.

The sub-frame diagram 440 illustrates the reporting of RI once every four sub-frames with CQI+PMI reported in every two sub-frame. Unlike the previous embodiment, no offset is introduced between CQI+PMI and RI reporting. Whenever a reporting collision occurs, RI is reported together with CQI+PMI in the same reporting instances. This illustrates a multiplexing embodiment with CQI+PMI reported every N, sub-frames and RI reported every N₂≧N₁ sub-frames where no offset is introduced between CQI+PMI and RI reporting. Whenever a reporting collision occurs, RI is reported together with, but separately encoded from CQI+PMI, in the same reporting instances.

The sub-frame diagrams 450 and 460 illustrate two examples where ACK/NAK occurs in several sub-frames during the CQI+PMI and RI reporting. In the sub-frame diagram 450, ACK/NAK can be signaled together with RI or CQI+PMI or signaled by itself when neither CQI+PMI nor RI is reported in a particular sub-frame. This multiplexing embodiment is an extension of the sub-frame diagram 430 with ACK/NAK signaling. On the other hand, the sub-frame diagram 460 is the corresponding extension of the sub-frame diagram 440 where ACK/NAK can be signaled together with CQI+PMI and separately encoded RI when RI is reported in the same reporting instance as CQI+PMI. Elsewhere, ACK/NAK is signaled together with CQI+PMI or by itself. Note that ACK/NAK can occur in any sub-frame and not periodically.

It should be noted that all the corresponding embodiments in FIGS. 4A through 4G assume PMI reporting which is applicable for closed-loop spatial multiplexing. The embodiments can be made applicable to open-loop spatial multiplexing by removing PMI from the reporting. That is, only CQI and RI are reported.

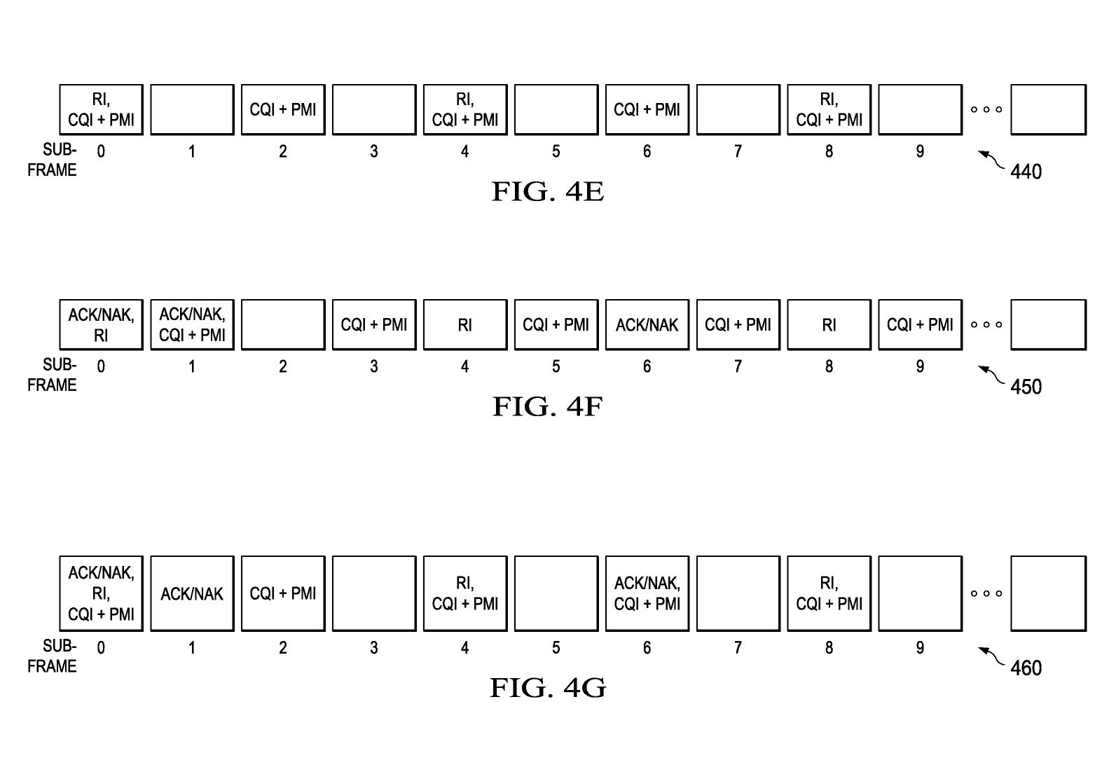

FIG. 5 illustrates a flow diagram of an embodiment of a method of operating a feedback encoder 500 carried out according to the principles of the present disclosure. The method 500 is for use with user equipment and starts in a step 505. Then, a separately reportable rank indicator for the user equipment is provided in a step 510. A related selection of at least one of a channel quality indicator and a preceding matrix indicator for the user equipment is provided in a step 515. In one embodiment, the rank indicator and the related selection conform to an OFDMA specification.

In one embodiment, a reporting interval of the rank indicator is equal to or greater than a corresponding reporting interval of the related selection. Alternately, a reporting interval of the rank indicator is equal to or greater than a maximum of possible values of a corresponding reporting interval of the related selection. Additionally, a reporting interval of the rank indicator may be greater than a single radio frame.

In one embodiment, the rank indicator is separately encoded from an acknowledged/not acknowledged signal in a same reporting instance. Alternatively, the rank indicator may be jointly encoded with an acknowledged/not acknowledged signal in a same reporting instance. The related selection corresponds to a joint encoding of the channel quality indicator and the precoding matrix indicator and a separate encoding of an acknowledged/not acknowledged signal in a same reporting instance.

In one embodiment, the related selection corresponds to a joint encoding of the channel quality indicator, the precoding matrix indicator and an acknowledged/not acknowledged signal in a same reporting instance. Alternately, the related selection may correspond to a joint encoding of the channel quality indicator and the preceding matrix indicator.

In one embodiment, the rank indicator and the related selection are reported in a same reporting instance. Alternately, the rank indicator and the related selection may be reported in different reporting instances. The rank indicator and the related selection are transmitted in a step 520, and the method 500 ends in a step 525.

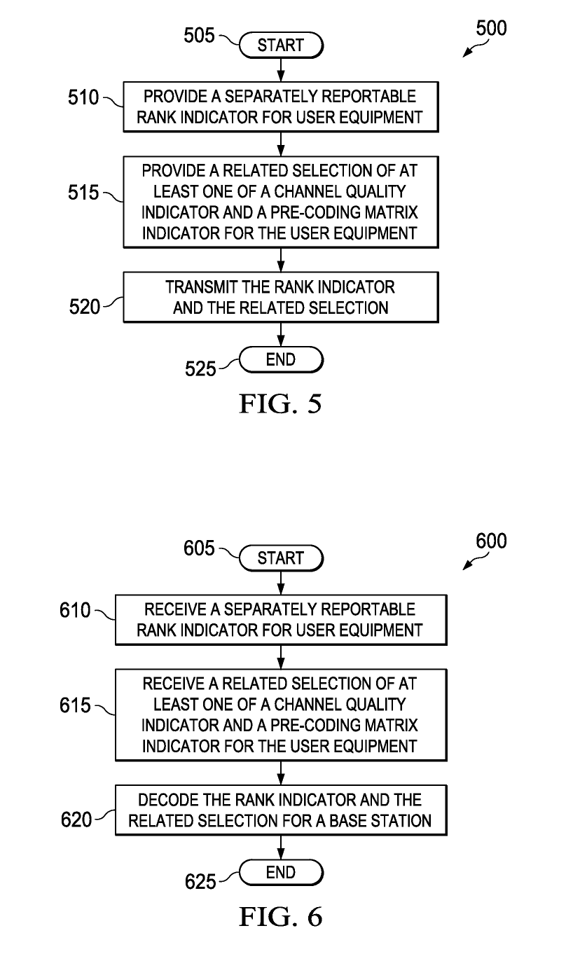

FIG. 6 illustrates a flow diagram of an embodiment of a method of operating a feedback decoder 600 carried out according to the principles of the present disclosure. The method 600 is for use with a base station and starts in a step 605. Then, a separately reportable rank indicator for the user equipment is received in a step 610. A related selection of at least one of a channel quality indicator and a preceding matrix indicator for the user equipment is received in a step 615. In one embodiment, the rank indicator and the related selection conform to an OFDMA specification.

In one embodiment, a reporting interval of the rank indicator is equal to or greater than a corresponding reporting interval of the related selection. Alternately, a reporting interval of the rank indicator is equal to or greater than a maximum of possible values of a corresponding reporting interval of the related selection. Additionally, a reporting interval of the rank indicator may be greater than a single radio frame.

In one embodiment, the rank indicator is separately encoded from an acknowledged/not acknowledged signal in a same reporting instance. Alternatively, the rank indicator may be jointly encoded with an acknowledged/not acknowledged signal in a same reporting instance. The related selection corresponds to a joint encoding of the channel quality indicator and the preceding matrix indicator and a separate encoding of an acknowledged/not acknowledged signal in a same reporting instance.

In one embodiment, the related selection corresponds to a joint encoding of the channel quality indicator, the preceding matrix indicator and an acknowledged/not acknowledged signal in a same reporting instance. Alternately, the related selection may correspond to a joint encoding of the channel quality indicator and the preceding matrix indicator.

In one embodiment, the rank indicator and the related selection are reported in a same reporting instance. Alternately, the rank indicator and the related selection may be reported in different reporting instances. The rank indicator and the related selection are decoded in a step 620, and the method 600 ends in a step 625.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which the disclosure relates will appreciate that other and further additions, deletions, substitutions and modifications may be made to the described example embodiments without departing from the disclosure.

What is claimed is:

1. A feedback encoder for use with user equipment, comprising:
an encoding module configured to provide a rank indicator that is separately reportable from a related selection of at least one of a channel quality indicator and a. Preceding matrix indicator for the user equipment; and
a transmit module configured to transmit the rank indicator and the related selection.

2. The feedback encoder as recited in claim 1 wherein the related selection corresponds to a joint encoding of the channel quality indicator and the preceding matrix indicator.

3. The feedback encoder as recited in claim 1 wherein the rank indicator and the related selection are reported in a same reporting instance.

4. The feedback encoder as recited in claim 1 wherein the rank indicator and the related selection are reported in different reporting instances.

5. The feedback encoder as recited in claim 1 wherein a reporting interval of the rank indicator is equal to or greater than a corresponding reporting interval of the related selection.

6. The feedback encoder as recited in claim 1 wherein a reporting interval of the rank indicator is greater than a single radio frame.

7. The feedback encoder as recited in claim 1 wherein a reporting interval of the rank indicator is equal to or greater than a maximum of possible values of a corresponding reporting interval of the related selection.

8. The feedback encoder as recited in claim 1 wherein the related selection corresponds to a joint encoding of the channel quality indicator and the preceding matrix indicator and a separate encoding of an acknowledged/not acknowledged signal in a same reporting instance.

9. The feedback encoder as recited in claim 1 wherein the rank indicator is separately encoded from an acknowledged/not acknowledged signal in a same reporting instance.

10. The feedback encoder as recited in claim 1 wherein the rank indicator is jointly encoded with an acknowledged/not acknowledged signal in a same reporting instance.

11. The feedback encoder as recited in claim 1 wherein the related selection corresponds to a joint encoding of the channel quality indicator, the preceding matrix indicator and an acknowledged/not acknowledged signal in a same reporting instance.

12. The feedback encoder as recited in claim 1 wherein the rank indicator and the related selection conform to an OFDMA specification.

13. A method of operating a feedback encoder for use with user equipment, comprising:
providing a rank indicator that is separately reportable from a related selection of at least one of a channel quality indicator and a preceding matrix indicator for the user equipment; and
transmitting the rank indicator and the related selection.

14. The method as recited in claim 13 wherein the related selection corresponds to a joint encoding of the channel quality indicator and the preceding matrix indicator.

15. The method as recited in claim 13 wherein the rank indicator and the related selection are reported in a same reporting instance.

16. The method as recited in claim 13 wherein the rank indicator and the related selection are reported in different reporting instances.

17. The method as recited in claim 13 wherein a reporting interval of the rank indicator is equal to or greater than a corresponding reporting interval of the related selection.

18. The method as recited in claim 13 wherein a reporting interval of the rank indicator is greater than a single radio frame.

19. The method as recited in claim 13 wherein a reporting interval of the rank indicator is equal to or greater than a maximum of possible values of a corresponding reporting interval of the related selection.

20. The method as recited in claim 13 wherein the related selection corresponds to a joint encoding of the channel quality indicator and the preceding matrix indicator and a separate encoding of an acknowledged/not acknowledged signal in a same reporting instance.

21. The method as recited in claim 13 wherein the rank indicator is separately encoded from an acknowledged/not acknowledged signal in a same reporting instance.

22. The method as recited in claim 13 wherein the rank indicator is jointly encoded with an acknowledged/not acknowledged signal in a same reporting instance.

23. The method as recited in claim 13 wherein the related selection corresponds to a joint encoding of the channel quality indicator, the preceding matrix indicator and an acknowledged/not acknowledged signal in a same reporting instance.

24. The method as recited in claim 13 wherein the rank indicator and the related selection conform to an OFDMA specification.

25. A feedback decoder for use with a base station, comprising:
a receive module configured to receive a rank indicator that is separately reportable from a related selection of at least one of a channel quality indicator and a preceding matrix indicator for user equipment; and
a decoding module configured to decode the rank indicator and the related selection for the base station.

26. The feedback decoder as recited in claim 25 wherein the related selection corresponds to a joint encoding of the channel quality indicator and the preceding matrix indicator.

27. The feedback decoder as recited in claim 25 wherein the rank indicator and the related selection are reported in a same reporting instance.

28. The feedback decoder as recited in claim 25 wherein the rank indicator and the related selection are reported in different reporting instances.

29. The feedback decoder as recited in claim 25 wherein a reporting interval of the rank indicator is equal to or greater than a corresponding reporting interval of the related selection.

30. The feedback decoder as recited in claim 25 wherein a reporting interval of the rank indicator is greater than a single radio frame.

31. The feedback decoder as recited in claim 25 wherein a reporting interval of the rank indicator is equal to or greater than a maximum of possible values of a corresponding reporting interval of the related selection.

32. The feedback decoder as recited in claim 25 wherein the related selection corresponds to a joint encoding of the channel quality indicator and the preceding matrix indicator and a separate encoding of an acknowledged/not acknowledged signal in a same reporting instance.

33. The feedback decoder as recited in claim 25 wherein the rank indicator is separately encoded from an acknowledged/not acknowledged signal in a same reporting instance.

34. The feedback decoder as recited in claim 25 wherein the rank indicator is jointly encoded with an acknowledged/not acknowledged signal in a same reporting instance.

35. The feedback decoder as recited in claim 25 wherein the related selection corresponds to a joint encoding of the channel quality indicator, the precoding matrix indicator and an acknowledged/not acknowledged signal in a same reporting instance.

36. The feedback decoder as recited in claim 25 wherein the rank and the related selection conform to an OFDMA specification.

37. A method of operating a feedback decoder for use with a base station, comprising:
receiving a rank indicator that is separately reportable from a related selection of at least one of a channel quality indicator and a preceding matrix indicator for user equipment; and
decoding the rank indicator and the related selection for the base station.

38. The method as recited in claim 37 wherein the related selection corresponds to a joint encoding of the channel quality indicator and the preceding matrix indicator.

39. The method as recited in claim 37 wherein the rank indicator and the related selection are reported in a same reporting instance.

40. The method as recited in claim 37 wherein the rank indicator and the related selection are reported in different reporting instances.

41. The method as recited in claim 37 wherein a reporting interval of the rank indicator is equal to or greater than a corresponding reporting interval of the related selection.

42. The method as recited in claim 37 wherein a reporting interval of the rank indicator is greater than a single radio frame.

43. The method as recited in claim 37 wherein a reporting interval of the rank indicator is equal to or greater than a maximum of possible values of a corresponding reporting interval of the related selection.

44. The method as recited in claim 37 wherein the related selection corresponds to a joint encoding of the channel quality indicator and the preceding matrix indicator and a separate encoding of an acknowledged/not acknowledged signal in a same reporting instance.

45. The method as recited in claim 37 wherein the rank indicator is separately encoded from an acknowledged/not acknowledged signal in a same reporting instance.

46. The method as recited in claim 37 wherein the rank indicator is jointly encoded with an acknowledged/not acknowledged signal in a same reporting instance.

47. The method as recited in claim 37 wherein the related selection corresponds to a joint encoding of the channel quality indicator, the preceding matrix indicator and an acknowledged/not acknowledged signal in a same reporting instance.

48. The method as recited in claim 37 wherein the rank indicator and the related selection conform to an OFDMA specification.
